(19) United States
(12) Patent Application Publication
(10) Pub. No.: US 2023/0025139 A1
(43) Pub. Date: Jan. 26, 2023

(54) DISPERSIONS

(71) Applicant: APPLIED GRAPHENE MATERIALS UK LIMITED, Redcar (GB)

(72) Inventors: William Weaver, Redcar (GB); Lynn Chikosha, Redcar (GB); J PFlaumer, Redcar (GB); A Karimi, Redcar (GB); R Weddell, Redcar (GB)

(21) Appl. No.: 17/625,462

(22) PCT Filed: Jul. 8, 2020
(86) PCT No.: PCT/GB2020/051649

§ 371 Date: Jan. 7, 2022

(30) Foreign Application Priority Data
Jul. 9, 2019 (GB) 1909801.1

(51) Int. Cl. C01B 32/184; C01B 32/21; C09D 17/00; C09D 7/45; C09D 7/65; C09D 7/61; C09D 7/40

(52) U.S. Cl. CPC C01B 32/184; C01B 32/21; C09D 17/004; C09D 17/001; C09D 7/45; C09D 7/65; C09D 7/61; C09D 7/70; C01B 2204/04; C01P 2004/24

(57) ABSTRACT

A method of forming a liquid dispersion of 2D material/graphitic nanoplatelets in an aqueous solution is disclosed. The method comprises the steps of (1) creating a dispersing medium; (2) mixing the 2D material/graphitic nanoplatelets into the dispersing medium; and (3) subjecting the 2D material/graphitic nanoplatelets to sufficient shear forces and or crushing forces to reduce the particle size of the 2D material/graphitic nanoplatelets using a mechanical means. The liquid dispersion comprises the 2D material/graphitic nanoplatelets, at least one grinding media, water, and at least one wetting agent, and that the at least one grinding media is water soluble or functionalised to be water soluble.

### CROSS REFERENCE TO RELATED APPLICATION

This application is a US national stage entry of international Patent Application No. PCT/GB2020/051649, filed Jul. 8, 2020, which claims priority to GB1909801.1, filed Jul. 9, 2019, the entire contents of each of which are incorporated by reference herein.

### TECHNOLOGICAL FIELD

This invention relates to dispersions and, in particular, to aqueous dispersions comprising two-dimensional (2D) materials and methods for making such dispersions.

### BACKGROUND

2D materials as referenced herein are comprised of one or more of the known 2D materials and or graphite flakes with at least one nanoscale dimension, or a mixture thereof. They are collectively referred to herein as “2D material/graphitic nanoplatelets” or “2D material/graphitic nanoplates”.

2D materials (sometimes referred to as single layer materials) are crystalline materials consisting of a single layer of atoms or up to several layers. Layered 2D materials consist of 2D layers weakly stacked or bound to form three dimensional structures. Nanoplates of 2D materials have thicknesses within the nanoscale or smaller and their other two dimensions are generally at scales larger than the nanoscale.

Known 2D nanomaterials, include but are not limited to, graphene (C), graphene oxide, reduced graphene oxide, hexagonal boron nitride (hBN), molybdenum disulphide (MoS₂), tungsten diselenide (WSe₂), silicene (Si), germanene (Ge), Graphyne (C), borophene (B), phosphorene (P), or 2D vertical or in-plane heterostructures of two of the aforesaid materials.

Graphite flakes with at least one nanoscale dimension are comprised of between 10 and 40 layers of carbon atoms and have lateral dimensions ranging from around 100 nm to 100 μm.

2D material/graphitic nanoplatelets and in particular graphene and hexagonal boron nitride have many properties of interest in the materials world and more properties are being discovered. A significant challenge to the utilisation of such materials and their properties is that of producing compositions in which such materials are dispersed and that can be made in commercial processes, and which are commercially attractive. In particular, such compositions must have a sufficient storage life/longevity for the substances to be sold, stored for up to a known period, and then used. Further, such compositions need not to be hazardous to the user and/or the environment, or at least any hazard has to be within acceptable limits.

A particular problem faced in connection with 2D material/graphitic nanoplatelets is their very poor dispersibility within water and aqueous solutions, and once dispersed, the poor stability of such dispersions. For example, graphene nanoplates and/or graphite nanoplates with one nanoscale dimension face this problem in water and aqueous solutions. Hexagonal boron nitride nanoplates face the same problems.

For 2D material/graphitic nanoplatelets which are known to be or suspected to be hazardous, especially when not encapsulated in other materials, the stability of those 2D material/graphitic nanoplatelets in dispersions is particularly important because they readily become airborne if they separate out of a dispersion and dry when not bound or encapsulated in a non-airborne substance. Airborne graphene nanoplates and or graphite nanoplates with at least one nanoscale dimension are considered to be potentially damaging to human and animal health if taken into the lungs. The hazards of other 2D material/graphitic nanoplatelets are still being assessed but it is believed prudent to assume that other 2D material/graphitic platelets will offer similar hazards.

2D material/graphitic nanoplatelets have a high surface area and low functionality which has the result that they have historically proven very difficult to wet and or disperse within water or aqueous solutions. Furthermore, the aggregation of the 2D material/graphitic nanoplatelets once dispersed is known to be very difficult to prevent.

Improved methods of wetting and achieving dispersion stability in non-aqueous solutions such as organic solvents and aqueous solutions have been the subject of intense research since the discovery of 2D material/graphitic nanoplatelets and their properties.

The parameters for creating good dispersions are well established in the field of colloid science and the free energy of any colloid system is determined by both the interfacial area and interfacial tension. The theoretical surface area of a monolayer of graphene is approximately 2590 m²g⁻¹ and consequently there are a limited range of conditions under which it can be dispersed, typically these conditions have included sonication and the use of polar aprotic solvents.

To maintain the stability of graphene/graphitic nanoplatelets (where the graphitic nanoplatelets are graphite nanoplates with nanoscale dimensions and 10 to 20 layers and lateral dimensions ranging from around 100 nm to 100 μm) in a dispersion once they have been dispersed requires the generation of an energy barrier to prevent aggregation of those nanoplatelets. This can be achieved by either electrostatic or steric repulsion. If the energy barrier is sufficiently high then Brownian motion will maintain the dispersion. This has been achieved by use of one or more approaches which may be characterised as:

a. Solvent selection;

b. Chemical (covalent) modification of the graphene/graphitic nanoplatelets; and

c. Non-covalent modification of the graphene/graphitic nanoplatelets.

a. Solvent Selection

Several solvents have been identified as being particularly good at dispersing graphene/graphitic nanoplatelets, in particular N-Methyl-2-pyrrolidone (NMP), Dimethyl sulfoxide (DMSO), and Dimethylformamide (DMF). These solvents carry with them health and safety problems and it is desirable not to use these solvents.

Solvent interaction has been rationalized in terms of both surface energy and the use of Hansen solubility parameters. Using Hansen solubility parameters has resulted in the identification of several solvents as potential carrier media, their effectiveness is, however, dependent on the functionality of the graphene/graphitic nanoplatelets, the mode of dispersion, the time since dispersion and/or the temperature of the dispersion.

Water is not, however, a solvent that interacts well with graphene/graphitic nanoplatelets. Water is a solvent with a high level of polarity while graphene/nanoplatelets have a high degree of hydrophobicity. This makes water and graphene/graphitic nanoplatelets repel each other and causes the graphene/graphitic nanoplatelets to aggregate, flocculate and not disperse.

b. Chemical (Covalent) Modification of Graphene/Graphitic Nanoplatelets

Functionalisation of graphene/graphitic nanoplatelets depends significantly on the level of functional group availability. Where oxygen is present (for example in reduced graphene oxide) one of the most popular routes is the use of diazonium salts to introduce functionality.

Alternatively, where there is either no functionality (pure graphene or graphite) or very low functionality, plasma modification may be used to introduce functionality. These graphene/graphitic nanoplatelets may subsequently be further treated to produce new functional species. The most important processing parameter for plasma treatment is the process gas because this determines the chemical groups introduced while the process time and power used impact the concentration of functional groups introduced.

It has been observed that although chemical functionalisation of graphene/graphitic nanoplatelets can improve their dispersibility, that chemical functionalisation can also increase the level of defects within the graphene sp2 structure and have a negative impact on properties such as electrical conductivity. This is clearly an undesirable outcome.

c. Non-Covalent Modification of Graphene/Graphitic Nanoplatelets

Non-covalent modification of graphene/graphitic nanoplatelets has several advantages over covalent modification in that it does not involve additional chemical steps and avoids damage to the sp2 domains within a nanoplatelet. There are a range of interactions possible, the principle being π-π, cation −π, and the use of surfactants.

π-π bonding may be achieved either through dispersive or electrostatic interactions.

A wide range of aromatic based systems have been shown to interact with graphene such as polyaromatic hydrocarbons (PAH), pyrene, and polyacrylonitrile (PAN).

Cation −π bonding may use either metal or organic cations. Organic cations are generally preferred with imidazolium cations being preferred due to the planar and aromatic structures of those cations.

Surfactants have found wide utilization due to the wide variety of surfactants available commercially. Typically, surfactants will initially be adsorbed at the basal edges of a nanoplate and then be adsorbed at the surface. Adsorption is enhanced if there is a capacity for π-π interaction and a planar tail capable of solvation. Both non-ionic and ionic surfactants have been shown to be effective based on the functionality of the graphene/graphitic nanoplatelets basal edge and surface and the media in which the graphene/graphitic nanoplatelets is being dispersed.

To summarise the discussion above, highly specialised additives are needed to wet, disperse and stabilise dry powders of graphene/graphitic nanoplatelets for use in liquid formulations using organic solvents. The same is understood to be true in connection with other 2D material/graphitic nanoplatelets.

The use of organic solvents in the environment is an issue of increasing concern and there is a general desire, where possible, to lower or eliminate organic solvent from the environment.

### BRIEF SUMMARY

According to a first aspect of the present invention there is provided a method of forming a liquid dispersion of 2D material/graphitic nanoplatelets in water or an aqueous solution comprising the steps of

(1) creating a dispersing medium;

(2) mixing 2D material/graphitic nanoplatelets into the dispersing medium; and

(3) subjecting the 2D material/graphitic nanoplatelets to sufficient shear forces and or crushing forces to reduce the particle size of the 2D material/graphitic nanoplatelets using a mechanical means

characterised in that the 2D material/graphitic nanoplatelets and dispersing medium mixture comprises the 2D material/graphitic nanoplatelets, at least one grinding media, water, and at least one wetting agent, and that the at least one grinding media is water soluble or functionalised to be water soluble.

Step (2) of the first aspect of the present invention is performed to achieve initial wetting of the 2D material/graphitic platelets prior to Step (3).

According to a second aspect of the present invention there is provided a dispersion comprising 2D material/graphitic nanoplatelets, at least one grinding media, water, and at least one wetting agent in which the at least one grinding media is water soluble or functionalised to be water soluble.

According to a third aspect of the present invention there is provided a liquid coating system comprising a dispersion according to the second aspect of the present invention.

In some embodiments of the first aspect of the present invention the 2D material/graphitic nanoplatelets are comprised of one or more of graphene or graphitic nanoplatelets, in which the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic platelets are comprised of graphite nanoplates with at least 10 layers of carbon atoms.

In some embodiments the present invention one or both of the graphene nanoplatelets and the graphitic nanoplatelets have lateral dimensions ranging from around 100 nm to 100 μm.

In some embodiments of the first aspect of the present invention the 2D material/graphitic nanoplatelets are comprised of one or more of graphitic nanoplatelets, in which the graphitic nanoplatelets are graphite nanoplates with 10 to 20 layers of carbon atoms, graphite nanoplates with 10 to 14 layers of carbon atoms, graphite nanoplates with 10 to 35 layers of carbon atoms graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms.

In some embodiments of the first aspect of the present invention the 2D material/graphitic nanoplatelets are comprised of one or more of 2D material nanoplatelets, in which the 2D material platelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

Few-layer graphene/reduced graphene oxide nanoplates have between 4 and 10 layers of carbon atoms, where a monolayer has a thickness of 0.035 nm and a typical interlayer distance of 0.14 nm.

In some embodiments of the first aspect of the present invention the 2D material/graphitic nanoplatelets are comprised of graphene/graphitic platelets and at least one 1D material. In some embodiments the 1D material comprises carbon nanotubes.

In some embodiments of the first aspect of the present invention the grinding media is a polymer modified with strong anchoring groups, a grinding resin, an aqueous solution of a modified aldehyde resin having at least one amine group, a low molecular weight styrene/maleic anhydride copolymer, or a mixture of these media.

In some preferred embodiments, the grinding media of the dispersion of 2D material/graphitic nanoplatelets is Laropal (trade mark) LR 9008 which is a water-soluble modified aldehyde resin commercially available from BASF, Dispersions & Resins Division, North America, ADDITOL (trade mark) XL 6515 a modified alkyd polymer, ADDITOL XW 6528 a polyester modified acrylic polymer, ADDITOL XW 6535 a high polymeric, auto emulsifying pigment grinding medium, ADDITOL XW 6565 a high polymeric, auto-emulsifying pigment grinding medium, ADDITOL XW 6591 a polyester modified acrylic polymer. The ADDITOL products are commercially available from the Allnex group of companies.

In some embodiments of the first aspect of the present invention the dispersing medium comprises a mixture of the at least one grinding media and water, and the step of creating a dispersing medium comprises

(i) mixing the at least one grinding media with the water until it is substantially homogenous.

In some embodiments of the first aspect of the present invention the at least one grinding media is a liquid and the dispersing medium comprises between 50 wt % and 90 wt % of the at least one grinding media and between 10 wt % and 50 wt % of water, between 60 wt % and 80 wt % of the at least one grinding media and between 20 wt % and 40 wt % of water; between 65 wt % and 75 wt % of the at least one grinding media and between 25 wt % and 35 wt % of water, or around 70 wt % of the at least one grinding media and around 30 wt % of water.

In some embodiments of the first aspect of the present invention the method further comprises the steps of

(ii) adding the 2D material/graphitic nanoplatelets to the at least one grinding media and water mixture following completion of step (i), and

(iii) mechanically mixing the 2D material/graphitic nanoplatelets and the at least one grinding media and water mixture until the 2D material/graphitic nanoplatelets are substantially dispersed in the grinding media solution.

In some embodiments of the first aspect of the present invention the dispersing medium further comprises the at least one wetting agent, the wetting agent is stored as a liquid, and the step of creating the dispersing medium comprises

(i) mixing the at least one grinding media, water and wetting agent until the grinding media, water and wetting agent mixture is substantially homogenous.

In some embodiments of the first aspect of the present invention the dispersing medium further comprises the at least one wetting agent, the wetting agent is stored as a solid (which includes powders), and the step of creating a dispersing medium comprises

(i) mixing the at least one grinding media, water and wetting agent until the wetting agent is dissolved and the grinding media, water and wetting agent mixture is substantially homogenous.

In some embodiments of the first aspect of the present invention the at least one wetting agent is added to the dispersing medium at substantially the same time as the 2D material/graphitic nanoplatelets.

The wetting agent or agents of the present invention may be one of a polymeric wetting agent, an ionic wetting agent, a polymeric non-ionic dispersing and wetting agent, a cationic wetting agent, an amphoteric wetting agent, a Gemini wetting agent, a highly molecular resin-like wetting and dispersing agent or a mixture of two or more of these wetting agents. Gemini wetting agents have two polar centres or head groups in the polyether segment which are connected by a spacer segment.

Preferred wetting agents of the dispersion of 2D material/graphitic nanoplatelets include but are not limited to ADDITOL (trade mark) VXW 6208/60, a modified acrylic copolymer which is a polymeric non-ionic dispersing and wetting additive commercially available from Allnex Belgium SA/NV; and DISPERBYK-2150 (trade mark) a block copolymer with basic, pigment-affinic groups commercially available from BYK-Chemie GmbH, and Surfynol (trade mark) 104 a Gemini wetting agent and molecular defoamer commercially available from Evonik Nutrition & Care GmbH.

Dry 2D material/graphitic nanoplatelets, for example graphene/graphitic nanoplatelets, are typically made up of agglomerates or aggregates of primary particles or nanoplatelets. During the dispersion process those agglomerates or aggregates have to be broken down, as far as possible, into primary particles or nanoplatelets of a size suitable for the intended application of the 2D material/graphitic nanoplatelets. The breaking down of the agglomerates or aggregates of primary particles or nanoplatelets is believed to include the process of exfoliation.

In some embodiments of the present invention the dispersing means is a means suitable to apply both a crushing action and a mechanical shearing force to the 2D material/graphitic platelets whilst those materials are mixed in with the dispersing medium. Suitable apparatus to achieve this are known grinding or milling apparatus such as dissolvers, bead mills or three-roll mills.

In some embodiments of the present invention it is preferred that the agglomerates or aggregates are broken down to particles or nanoplatelets of a particle size which cannot be broken down further. This is beneficial because the manufacture and storage of 2D material/graphitic nanoplatelets prior to their use is often in the form of particles that are larger than desired for 2D material/graphitic nanoplatelet dispersions.

Once the 2D material/graphitic nanoplatelet agglomerates or aggregates are reduced to smaller particles or nanoplatelets, rapid stabilisation of the newly formed surfaces resultant from the reduction in size of the agglomerates or aggregates helps to prevent the particles or nanoplatelets re-agglomerating or re-aggregating.

The method of the present invention is particularly beneficial because it has been found that the higher the interfacial tension between a dispersing medium, for example a dispersing medium which comprises water and 2D material/graphitic nanoplatelets, the stronger are the forces tending to reduce the interfacial area. In other words, the stronger are the forces tending to re-agglomerate or re-aggregate the 2D material/graphitic nanoplatelets or to form flocculates. The interfacial tension between a wetting agent in the dispersing medium and the 2D material/graphitic nanoplatelets is lower than that between the water and the 2D nanomaterial and as such the wetting agent helps stabilise the newly formed surfaces and prevent the 2D material/graphitic nanoplatelets agglomerating, aggregating and or flocculating.

The action of the wetting agent in stabilising the newly formed surfaces and preventing the 2D material/graphitic nanoplatelets agglomerating, aggregating and or flocculating is beneficial but has been found not to give sufficient benefit to allow the formation of improved stable dispersions. This is because although the wetting agent will allow the 2D nanomaterial to be suspended in an aqueous dispersing medium, it is a feature of 2D material/graphitic nanoplatelets that they have a high surface area relative to other compounds. Water having a high polarity may displace the wetting agent.

An increase in the proportion of the wetting agent in the dispersing medium may, ultimately lead to a dispersion in which all the components remain suspended. This approach to forming a dispersion has the problem, however, that coatings formed from the dispersion will have a high degree of solubility in water. This is very undesirable because it leads to the rapid failure of the coating.

According to the present invention the application of a crushing action and mechanical shearing forces to a dispersion comprising a mixture of 2D material/graphitic nanoplatelets in a grinding media, water and wetting agent mixture results in an improved dispersion.

This is thought to be because, in addition to the wetting agent, the grinding media will also stabilise the newly formed surfaces of the 2D material/graphitic platelets because a proportion of the 2D material/graphitic nanoplatelets are at least partially encapsulated within a coating of grinding media. The wetting agent can then bond with the combined grinding media/2D material/graphitic nanoplatelet particle and allow the grinding media/2D material/graphitic nanoplatelet particle to be suspended in the dispersion. The grinding media requires less wetting agent than the 2D material/graphitic nanoplatelets to allow suspension in the dispersion so the problems with requiring too much wetting agent and the resultant high solubility of any coating formed from the dispersion are avoided.

It is thought that this is because water as a solvent has a high level of polarity while, in contrast, graphene/graphitic nanoplatelets with a high Carbon/Oxygen ratio have a low polarity and a high degree of hydrophobicity which makes the two repel each other. This causes the graphene/graphitic nanoplatelets to aggregate, flocculate and not disperse. In some embodiments of the present invention where the 2D material/graphitic platelets are graphene/graphitic nanoplatelets the Carbon/Oxygen ratio of the graphene/graphitic nanoplatelets is equal to or greater than 15.

A further advantage of the method of the present invention is that the milling performance of the dispersion means when acting on 2D material/graphitic nanoplatelets, is further improved by the presence of the grinding media in the mixture being milled. That improvement is exhibited by faster milling, lower heat generation in the milling process, a more uniform particle size in the dispersion, a smaller D50 particle size in the dispersion, a lower dispersion viscosity, a greater storage stability relative to known short shelf life dispersions, and an ability to re-disperse any combined grinding media/2D material/graphitic nanoplatelets particles that have settled out of the dispersion by simple agitation of the dispersion.

The use of the grinding media allows for lower use of wetting agent in creating the dispersion than would be expected thus minimising solubility issues with coatings formed from coating systems incorporating dispersions made according to present invention.

According to a second aspect of the present invention there is provided a liquid dispersion comprising 2D material/graphitic nanoplatelets, at least one grinding media, water, and at least one wetting agent.

In some embodiments of the second aspect of the present invention the 2D material/graphitic nanoplatelets are comprised of one or more of graphene nanoplatelets, graphitic nanoplatelets, and 2D material nanoplatelets and in which the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic nanoplatelets are comprised of graphite nanoplates with at least 10 layers of carbon atoms, the graphitic nanoplatelets are comprised of one or more of graphite nanoplates with 10 to 20 layers of carbon atoms, graphite nanoplates with 10 to 14 layers of carbon atoms, graphite nanoplates with 10 to 35 layers of carbon atoms graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms, and the 2D material nanoplatelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

In some embodiments of the second aspect of the present invention the 2D material/graphitic nanoplatelets comprises at least one 1D material.

In some embodiments of the second aspect of the present invention the at least one grinding media is a polymer modified with strong anchoring groups, an aqueous solution of a modified aldehyde resin having at least one amine group, or a low molecular weight styrene/maleic anhydride copolymer.

In some preferred embodiments, the grinding media of the dispersion of 2D material/graphitic platelets is Laropal (trade mark) LR 9008 which is a water-soluble modified aldehyde resin commercially available from BASF, Dispersions & Resins Division, North America, ADDITOL (trade mark) XL 6515 a modified alkyd polymer, ADDITOL XW 6528 a polyester modified acrylic polymer, ADDITOL XW 6535 a high polymeric, auto emulsifying pigment grinding medium, ADDITOL XW 6565 a high polymeric, auto-emulsifying pigment grinding medium, ADDITOL XW 6591 a polyester modified acrylic polymer. The ADDITOL products are commercially available from the Allnex group of companies.

In some embodiments of the second aspect of the present invention the wetting agent is comprised of one of a polymeric wetting agent, an ionic wetting agent, a polymeric non-ionic dispersing and wetting agent, a cationic wetting agent, an amphoteric wetting agent, a Gemini wetting agent, a highly molecular resin-like wetting and dispersing agent or a mixture of two or more of these wetting agents.

Preferred wetting agents include but are not limited to ADDITOL (trade mark) VXW 6208/60, a modified acrylic copolymer which is a polymeric non-ionic dispersing and wetting additive commercially available from Allnex Belgium SA/NV; and DISPERBYK-2150 (trade mark) a block copolymer with basic, pigment-affinic groups commercially available from BYK-Chemie GmbH, and Surfynol 104 (trade mark) a combined Gemini wetting agent and molecular defoamer commercially available from Evonik Nutrition & Care.

In some embodiments of the second aspect of the present invention the liquid dispersion is manufactured using a method according to the first aspect of the present invention.

### BRIEF DESCRIPTION

For a better understanding of various examples that are useful for understanding the detailed description, reference will now be made by way of the examples below.

### DETAILED DESCRIPTION

### Examples

Typical formulations of dispersions according to the present invention are set out in tables 1 and 2 below:

All dispersions were manufactured on an Eiger Torrance 250, horizontal beadmill. Dispersions were milled for 15 minutes on recirculation mode at maximum speed.

Characterisation of Dispersions

Particle size was measured on a Mastersizer 3000 to determine the effectiveness of the grinding resin and dispersant in deagglomeration and particle size reduction.

Viscosity was measured to aid understanding of the rheological properties of the dispersion. This was done using a Kinexus Rheometer.

Storage stability was determined through the use of a Turbiscan Stability Analyser. Turbiscan stability index (TSI) is a relative measure of stability, which allows comparison of multiple samples. As a relative measure, it allows for a quantifiable assessment of closely related formulations.

Stability tests were carried out at ambient and elevated temperature (40 C).

TABLE 1

| Component | % by weight |
|---|---|
| A-GNP35 | 0.5 |
| Surfynol 104 | 0.1 |
| Water | 29.82 |
| Laropal LR9008 | 69.58 |

TABLE 2

| Component | % by weight |
|---|---|
| A-GNP10 | 10 |
| Surfynol 104 | 2 |
| Water | 26.4 |
| Laropal LR9008 | 61.6 |

Graphitic material A-GNP10 is commercially available from Applied Graphene Materials UK Limited, UK and comprises graphite nanoplatelets of between 25 and 35 layers of atoms thick. The graphite nanoplatelets are supplied as a powder and are generally aggregated into clumps of nanoplatelets.

Graphene/graphitic material A-GNP35 is commercially available from Applied Graphene Materials UK Limited, UK and comprises graphene/graphite nanoplatelets of between 5 and 15 layers of atoms thick. The graphite nanoplatelets are supplied as a powder and are generally aggregated into clumps of nanoplatelets.

Each of the dispersions was made up using the following steps:

1 To the water the Surfynol 104 and Laropal LR9008 were added. This was stirred until the mixture was substantially homogenous;

2 The A-GNP-10 or A-GNP-35 was added to the mixture and stirred until the powder was evenly dispersed in the mixture;

3 The mixture was bead milled for 15 minutes recirculation in a bead mill using beads.

### DISCUSSION

Graphene (A-GNP10) Dispersed in Water Only

A-GNP10 was dispersed in water at four different concentrations: 0.1, 1, 5 and 10%. Samples were stored for 4 weeks under ambient conditions.

Samples at 5 and 10% sedimented within 2 to 3 days of manufacture

Samples at 0.1 and 1% had not yet visibly sedimented, 4 weeks after manufacture.

The degree of heavy sedimentation seen in 5 and 10% weight additions of graphene (A-GNP10), raised the need to identify a suitable pigment dispersing resin (i.e. grinding media) and/or surfactant (i.e. wetting agent) to improve shelf life and storage stability of the product.

Graphene (A-GNP10) Dispersed in Water Comprising a Dispersing Resin (i.e. Grinding Media)

Dispersions Tested

10% A-GNP10 was dispersed into a range of media, with increasing loadings of the grinding media Laropal LR9008:
1. Water only
2. 10% Laropal 90% water blend
3. 20% Laropal 80% water blend
4. 30% Laropal 70% water blend
5. 40% Laropal 60% water blend
6. 50% Laropal 50% water blend

Viscosity of Aqueous Dispersions of A-GNP10

All dispersions had a very low viscosity (less than 1 PaS), as shown in table 3 below. Overall, there were no significant changes to the rheological profile of these dispersions. However, the dispersion of 10% Laropal LR9008 and 90% water showed particularly high viscosity.

TABLE 3
Viscosity of Aqueous Dispersions of A-GNP10

| 10% A-GNP10 in: | Viscosity (Pa · s) |
|---|---|
| Water only | 0.024 |
| 10% Laropal + 90% | 0.32 |
| Water | |
| 20% Laropal + 80% | 0.0063 |
| Water | |
| 30% Laropal + 70% | 0.026 |
| Water | |
| 40% Laropal + 60% | 0.013 |
| Water | |
| 50% Laropal + 50% | 0.0094 |
| Water | |

Particle Size Distribution of Aqueous Dispersions of A-GNP10

Particle size distribution was monitored for all samples, the results of which are shown in table 4 below. With the exception of the dispersion with 10% loading of Laropal, all dispersions showed a D90 in the range of 15-25 microns.

TABLE 4
Particle Size Distribution of Aqueous Dispersions of A-GNP10

| % Laropal | D10 | D50 | D90 |
|---|---|---|---|
| Wafer only | 0.258 | 1.98 | 14.8 |
| 10% Laropal + 90% | 1.04 | 6.63 | 42.4 |
| Wafer | | | |
| 20% Laropal + 80% | 0.486 | 3.63 | 23.2 |
| Water | | | |
| 30% Laropal + 70% | 0.349 | 2.33 | 15.2 |
| Water | | | |
| 40% Laropal + 60% | 0.402 | 3.35 | 18.2 |
| Wafer | | | |
| 50% Laropal + 50% | 0.342 | 2.55 | 15 |
| Water | | | |

Storage Stability of Aqueous Dispersions of A-GNP10

Samples were tested at ambient and elevated temperature (40° C.). In general, addition of Laropal LR 9008 generally improved stability to sedimentation.

Turbiscan Measurements—Multiple Light Scattering

Static multiple light scattering was carried out on the samples, and the results are shown in Table 5 below. Static multiple light scattering is an optical method used to characterise concentrated liquid dispersions. Light is transmitted into the sample and either backscattered or transmitted by the dispersion, depending on concentration and predominant particle size. TSI numbers are used to indicate the degree of change within a sample, with high numbers indicating high degree of change within the sample i.e. instability.

TABLE 5
Turbiscan assessment

| | | Elevated |
|---|---|---|
| | Ambient | Temperature Storage |
| % Laropal | Storage | (40° C.) |
| Wafer only | 0.3 | 2 |
| 10% Laropal + 90% | 4.5 | 6.4 |
| Wafer | | |
| 20% Laropal + 80% | 0.2 | 0.5 |
| Water | | |
| 30% Laropal + 70% | 0.3 | 0.6 |
| Water | | |
| 40% Laropal + 60% | 0.7 | 0.6 |
| Wafer | | |
| 50% Laropal + 50% | 0.3 | 0.6 |
| Water | | |

Comments

For dispersions of A-GNP10 in water, the presence of Laropal demonstrated improved stability as tested by the Turbiscan, with the only exception being the dispersion with 10% Laropal LR9008. In the absence of Laropal LR9008, dispersions were initially seen to sediment after 2 to 3 days on storage. With the use of the dispersing resin, stability to sedimentation was increased to 6 weeks.

Graphene (A-GNP35) Dispersed in Water Comprising a Dispersing Resin (i.e. Grinding Media)

Dispersions Tested

0.5% A-GNP35 was dispersed into water/solvent and bead-milled for 15 minutes recirculation.

0.5% A-GNP35 in
Water only
10% Laropal 90% water
20% Laropal 80% water
30% Laropal 70% water
40% Laropal 60% water
50% Laropal 50% water

Viscosity of Aqueous Dispersions of A-GNP35

Dispersions of A-GNP35 in water only tend to show a very high viscosity as shown in Table 6 below. For all systems tested, viscosity was lower with the addition of Laropal LR9008. The lowest viscosity was achieved at 20% loading of Laropal.

TABLE 6
Viscosity of Aqueous Dispersions of A-GNP35

| 0.5% A-GNP35 in: | Viscosity (Pa· s) |
|---|---|
| Water only | 22.51 |
| 10% Laropal + 90% | 0.07791 |
| Water | |
| 20% Laropal + 80% | 0.04852 |
| Water | |
| 30% Laropal + 70% | 0.06313 |
| Water | |
| 40% Laropal + 60% | 0.08151 |
| Water | |
| 50% Laropal + 50% | 0.1225 |
| Water | |

Particle Size Distribution of Aqueous Dispersions of A-GNP35

Particle size distribution was assessed for all samples, the results of which are shown in Table 7 below. The use of Laropal LR9008 was shown to reduce particle size significantly. For the systems which included Laropal, the dispersion with 10% loading of Laropal showed the least reduction in particle size distribution. Between 20 and 50% loading of Laropal, there was not much variation in particle size distribution. For these systems, D90 was half that achieved without the use of the dispersing resin (i.e. grinding media).

TABLE 7
Particle Size Distribution of Aqueous Dispersions of A-GNP10

| % A-GNP35 in: | D10 | D50 | D90 |
|---|---|---|---|
| Water only | 8.99 | 41.2 | 123 |
| 10% Laropal + 90% | 5.84 | 24.7 | 84.1 |
| Water | | | |
| 20% Laropal + 80% | 3.17 | 13.8 | 50.2 |
| Water | | | |
| 30% Laropal + 70% | 2.83 | 14.4 | 53.8 |
| Water | | | |
| 40% Laropal + 60% | 2.4 | 13 | 55.5 |
| Water | | | |
| 50% Laropal + 50% | 1.83 | 11 | 51.8 |
| Water | | | |

Storage Stability

Samples were tested at ambient and elevated temperature. Dispersions of A-GNP35 in water typically have a high viscosity with the consistency of a thick paste. As such, they tend to be more stable than the equivalent dispersions of A-GNP10. After one week testing, there was no visible difference in the stability of the samples, either on ambient or elevated temperature (40° C.) store.

Turbiscan assessment of the samples as shown in table 8 below revealed no significant differences in the stability index of the samples, either at ambient or elevated temperature. Turbiscan stability index (TSI) is a relative measure of stability, which allows comparison of multiple samples. As a relative measure, it allows for a quantifiable assessment of closely related formulations.

TABLE 8
Turbiscan assessment

| | | Elevated |
|---|---|---|
| | Ambient | Temperature Storage |
| 0.5% A-GNP35 in: | Storage | (40° C.) |
| Water only | 0.1 | 0.2 |
| 10% Laropal + 90% | 0.3 | 0.2 |
| Water | | |
| 20% Laropal + 80% | 0.2 | 0.2 |
| Water | | |
| 30% Laropal + 70% | 0.1 | 0.2 |
| Water | | |
| 40% Laropal + 60% | 0.1 | 0.2 |
| Water | | |
| 50% Laropal + 50% | 0.1 | 0.3 |
| Water | | |

Comments

For dispersions of A-GNP35 in water, the presence of Laropal significantly reduced dispersion viscosity, making dispersions more user friendly and easier to handle. Greater degree of particle size reduction was also achieved with the inclusion of Laropal.

Graphene (A-GNP35) Dispersed in Water Comprising a Dispersing Resin (i.e. Grinding Media) and a Wetting Agent (Surfynol)

Stability of the dispersion of Table 1 was monitored over a period of 4 months. Changes in particle size and degree of sedimentation were monitored. Four batches of the stabilised formulations were tested. Surfynol (wetting agent) was introduced to further improve pigment wetting and to act as a defoamer. The stabilised Formulation is as indicated in table 1 above.

Turbiscan—Multiple Light Scattering

Static Multiple Light Scattering is an optical method used to characterize concentrated liquid dispersions. Light is transmitted into the sample and either backscattered or transmitted by the dispersion, depending on concentration and predominant particle sizes. Any destabilization phenomenon happening in a given sample will have an effect on the backscattering and/or transmission signal intensities during the aging process. A formulation with high intensity variation, is changing in a significant way, and can be considered unstable.

Four batches of the dispersion of Table 1 were tested in order to understand stability of this dispersion. After 46 days on storage, there was development of surface separation, evidenced by the appearance of a transmitting (clear) layer near the surface. Immediately below the developing clear layer, was a slightly thicker layer where backscatter had increased.

Monitoring changes in Particle Size

Particle size distribution was assessed for the dispersion of Table 1, the results of which are shown in Table 9 below.

Changes in particle size can indicate agglomeration, aggregation or flocculation.

TABLE 9

| | Initial | 1 month | 4 months |
|---|---|---|---|
| D10 | 0.0385 | 0.0434 | 0.0416 |
| D50 | 4.43 | 4.78 | 4.34 |
| D90 | 16.2 | 17.7 | 13.2 |

A slight drop in initial D90 was recorded after 4 months. The initial increase from 16.2 to 17.7 is considered to be within measurement error.

Degree of Sedimentation

The degree of sedimentation is shown in table 10 below.

TABLE 10

| | Degree of sedimentation | Ease of mixing |
|---|---|---|
| Initial | No sedimentation | Easy |
| 1 month | No sedimentation | Easy |
| 4 months | No sedimentation | Easy |

Shelf Life Recommendations

The dispersion of Table 1 should be stored for a period of 3 months at ambient temperature (15 to 25° C.). Some separation may occur and this can be mixed back into a homogenous dispersion with light mechanical agitation.

1. A method of forming a liquid dispersion of 2D

1. A method of forming a liquid dispersion of 2D material/graphitic nanoplatelets in water or an aqueous solution comprising the steps of
(1) creating a dispersing medium by mixing at least one grinding media, water and at least one wetting agent until the grinding media, water and wetting agent mixture is substantially homogenous, in which the at least one grinding media is water soluble or functionalised to be water soluble and comprises an aqueous solution of a modified aldehyde resin having at least one amine group;
(2) mixing the 2D material/graphitic nanoplatelets into the dispersing medium; and
(3) subjecting the 2D material/graphitic nanoplatelets to sufficient shear forces and or crushing forces to reduce the particle size of the 2D material/graphitic nanoplatelets using a mechanical means
characterised in that the liquid dispersion comprises the 2D material/graphitic nanoplatelets, the at least one grinding media, the water, and the at least one wetting agent, in which the 2D material/graphitic nanoplatelets are comprised of one or more of graphene nanoplatelets, graphitic nanoplatelets, and 2D material nanoplatelets and in which
the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic nanoplatelets are comprised of graphite nanoplates with at least 10 layers of carbon atoms, the graphitic nanoplatelets are comprised of one or more of graphite nanoplates with 10 to 20 layers of carbon atoms, graphite nanoplates with 10 to 14 layers of carbon atoms, graphite nanoplates with 10 to 35 layers of carbon atoms, graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms, and the 2D material platelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

2. (canceled)

3. A method according to claim 1 in which the 2D material/graphitic nanoplatelets comprises at least one 1D material.

4. (canceled)

5. A method according to claim 1 in which the at least one wetting agent comprises one of a polymeric wetting agent, an ionic wetting agent, a polymeric non-ionic dispersing and wetting agent, a cationic wetting agent, an amphoteric wetting agent, a Gemini wetting agent, a highly molecular resin-like wetting and dispersing agent or a mixture of two or more of these wetting agents.

6. (canceled)

7. (canceled)

8. A method according to claim 1 in which the at least one wetting agent is stored in a liquid form.

9. A method according to claim 1 in which the at least one wetting agent is stored as a solid, and the step of creating a dispersing medium comprises
(i) mixing the at least one grinding media, water and wetting agent until the wetting agent is dissolved and the grinding media, water and wetting agent mixture is substantially homogenous.

10. A method according to claim 1 in which the at least one wetting agent is added to the dispersing medium at substantially the same time as the 2D material/graphitic platelets.

11. A method according to claim 1 in which the step (3) of subjecting the 2D material/graphitic nanoplatelets to sufficient shear forces and or crushing forces to reduce the particle size of the 2D material/graphitic nanoplatelets is performed using one or more of a dissolver, a bead mill, or a three-roll mill.

12. A liquid dispersion characterised in that the liquid dispersion comprises 2D material/graphitic nanoplatelets, at least one grinding media, water, and at least one wetting agent, and in which the at least one grinding media is water soluble or functionalised to be water soluble and comprises an aqueous solution of a modified aldehyde resin having at least one amine group,
in which the 2D material/graphitic nanoplatelets are comprised of one or more of graphene nanoplatelets, graphitic nanoplatelets, and 2D material nanoplatelets and in which
the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic nanoplatelets are comprised of graphite nanoplates with at least 10 layers of carbon atoms, the graphitic nanoplatelets are comprised of one or more of graphite nanoplates with 10 to 20 layers of carbon atoms, graphite nanoplates with 10 to 14 layers of carbon atoms, graphite nanoplates with 10 to 35 layers of carbon atoms, graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms, and the 2D material platelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

13. (canceled)

14. A liquid dispersion according to claim 12 in which the 2D material/graphitic nanoplatelets comprises at least one 1D material.

15. (canceled)

16. A liquid dispersion according to claim 12 in which the wetting agent is comprised of one of a polymeric wetting agent, an ionic wetting agent, a polymeric non-ionic dispersing and wetting agent, a cationic wetting agent, an amphoteric wetting agent, a Gemini wetting agent, a highly molecular resin-like wetting and dispersing agent or a mixture of two or more of these wetting agents.

17. A liquid dispersion according to claim 12 manufactured using a method according to claim 1.

18. A liquid coating composition comprising a liquid dispersion according to claim 12.
